(19) United States
(12) Patent Application Publication
(10) Pub. No.: US 2022/0246083 A1
(43) Pub. Date: Aug. 4, 2022

(54) ELECTRONIC DEVICE AND VIDEO WALL CONTROL METHOD

(71) Applicant: HONG FU JIN PRECISION INDUSTRY (WuHan) CO., LTD., Wuhan (CN)

(72) Inventors: WEI-TSUNG HUNG, New Taipei (TW); YI ZHOU, Shenzhen (CN); ZHEN-HUI LIAO, Shenzhen (CN); JIAN-PING YU, Shenzhen (CN); YONG-CHENG TANG, Shenzhen (CN); DONG-FENG WANG, Shenzhen (CN)

(21) Appl. No.: 17/429,775

(22) PCT Filed: May 15, 2020
(86) PCT No.: PCT/CN2020/090690

§ 371 Date: Apr. 22, 2022

(30) Foreign Application Priority Data
May 16, 2019 (CN) 201910407734.4

(51) Int. Cl. G09G 3/20; G06F 3/14; G06F 3/16

(52) U.S. Cl. CPC G09G 3/2092; G06F 3/1446; G09G 2354/00; G09G 2300/026; G09G 2370/042; G06F 3/16

(57) ABSTRACT

Provided in the present invention are a video wall control device and method. The video wall control device comprises: a processor, a memory, a video wall, and a control interface, wherein the memory is used for storing configuration information of multiple video devices; and the processor comprises a detection module for detecting whether the video wall control device receives a connection request from a video device; an acquisition module for acquiring, when the video wall control device receives a connection request from a video device, the configuration information of the video device; a determination module for determining the type of video device according to the acquired configuration information; a loading module for loading a video control service corresponding to the type of video device; and a control module for controlling, in response to the connection request and according to the loaded video control service, the content to be projected of the video device to he projected on a video wall. The present invention is convenient for a user to control multiple video devices of different types to project and display required content on a video wall.

The present application claims a priority of Chinese patent application filed on May 16, 2019, with an application number of 201910407734.4, and an invention title of “video wall control device and method”, the entire contents of which are incorporated into the present application by reference.

### TECHNICAL FIELD

The subject matter herein generally relates to video control, and particularly to a video wall control device and a video wall control method.

### BACKGROUND

With a development of science and technology, video control devices are widely used in video conferencing and video teaching. The video control devices can project videos on video walls through projection devices, so as to facilitate users to explain the videos to others. In prior art, the users can control windows displayed on the video wall and the videos displayed in each of the windows by the video control devices. However, if the video control devices in different brands or models require to display the videos on a same video wall, due to different control software and compatibility, the users cannot control the video control devices in the different brands or models to be operated using same instructions, which causes inconvenience to the users.

### SUMMARY

In view of this, it is necessary to provide a video wall control device and method, to solve the above technical problems.

A video wall control device, includes a processor, a storage device, a video wall, a control interface connecting with a number of video devices in different types, the storage device stores configuration information of the number of video devices, the processor includes:

a detecting module, configured to detect whether the video wall control device receives a connection request from at least one of the number of video devices;

an acquiring module, configured to acquire, in response that the video wall control device is detected to receive the connection request from the at least one of the number of video devices, configuration information of the at least one of the number of video devices;

a determining module, configured to determine a type of the at least one of the number of video devices according to the acquired configuration information;

a loading module, configured to load a video control service corresponding to the type of the number of at least one of the video devices; and

a projecting module, configured to project videos to be projected from the at least one of the number of video devices on the video wall according to the video control service loaded by the loading module in response to the connection request.

A video wall control method, implemented in a video wall control device, the video wall control device includes a storage device, a video wall, and a control interface, the control interface connects with a number of video devices in different types, the storage device stores configuration information of the number of video devices, the method includes:

detecting whether the video wall control device receives a connection request from at least one of the number of video devices;

acquiring, in response that the video wall control device is detected to receive the connection request from the at least one of the number of video devices, configuration information of the at least one of the number of video devices;

determining a type of the at least one of the number of video devices according to the acquired configuration information;

loading a video control service corresponding to the type of the number of at least one of the video devices; and

in response to the connection request, projecting videos to be projected from the at least one of the number of video devices on the video wall according to the loaded video control service.

The above-mentioned video wall control device and the video wall control method enable a video wall control service interface to connect with a number of video devices in different types, which is convenient for users to control the number of different types of video devices to display required content on a video wall, thereby improving user experience.

### BRIEF DESCRIPTION OF THE DRAWINGS

FIG. 1 is a block diagram of a preferred embodiment of a video wall control device according to the preset disclosure.

FIG. 2 illustrates a flowchart of a preferred embodiment of a video wall control method according to the preset disclosure.

### DESCRIPTION OF MAIN COMPONENT SYMBOLS

Video wall control device 1

Processor 10

Detecting module 101

Judging module 102

Feedback module 103

Acquiring module 104

Determining module 105

Loading module 106

Control module 107

Video wall control system 100

Video wall control interface 110

Storage device 20

Video wall 30

Control interface 40

Video device 2

The following detailed description will further illustrate the present disclosure in conjunction with the above drawings.

### DETAILED DESCRIPTION

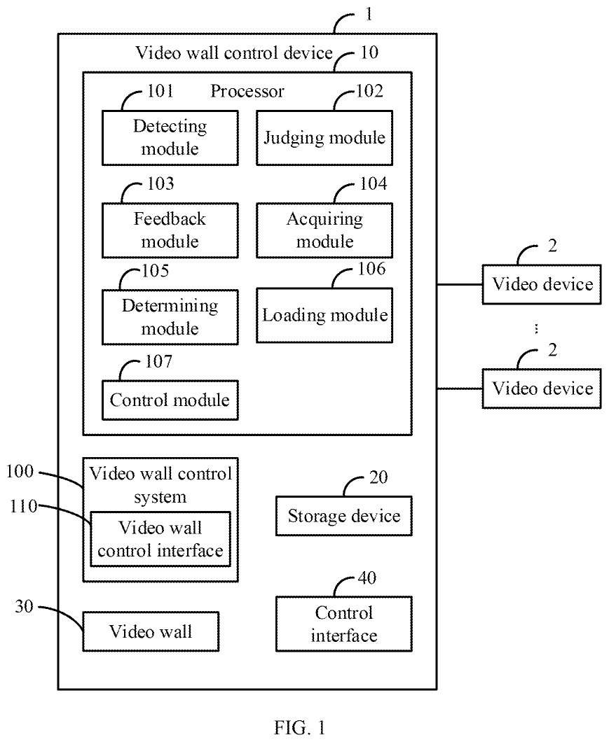

Referring to FIG. 1, FIG. 1 illustrates a block diagram of a preferred embodiment of a video wall control device 1 for controlling a video wall. The video wall control device 1 connects with a number of video devices in different types through a video control interface, so as to facilitate users to control the number of video devices in different types to project content to be displayed on a video wall. In one embodiment, the video wall control device 1 can be a projection device, such as a projector.

The video wall control device 1 includes, but is not limited to, a processor 10, a storage device 20, a video wall 30, and a control interface 40. In one embodiment, the processor 10 can be a microprocessor, a single chip microcomputer, or a system on chip (SOC). The storage device 20 can be a read-only memory or a random access memory. The storage device 20 is used to store configuration information of a number of video devices 2. The video wall 30 can be a projection screen or a common plane, the video wall 30 displays projection windows for displaying the content to be projected from the number of video devices 2.

In one embodiment, the control interface 40 can be a Video-Wall Control General API Interface (VWCGIAA), the control interface 40 communicates with the number of video devices 2 in different types. The different types recited in the present disclosure can be different brands or different models. In one embodiment, the video device 2 can be a personal computer. The video wall control device 1 can communicate with the video device 2 via the control interface 40, in response to connection requests from the video devices 2 in different types, and project the content to be projected in the projection window of the video wall 30 according to the video control service of each of the number of video devices 2, after the video wall control device 1 communicates with each of the number of video devices 2.

As illustrated in FIG. 1, the video wall control device 1 at least includes a detecting module 101, a judging module 102, a feedback module 103, an acquiring module 104, a determining module 105, a loading module 106, and a control module 107. In one embodiment, the modules 101-107 are programmable software instructions stored in the storage device 20 and invoked and executable by the processor 10. It can be understood that, in other embodiments, the modules 101-107 may also be program instructions or firmware integrated in the processor 10.

The detecting module 101 is used to detect whether the video wall control device 1 receives a connection request from at least one video device 2 in real time. In one embodiment, the detecting module 101 detects whether the video wall control device 1 receives the connection request from the video device 2 at predetermined time intervals. The predetermined time interval can be ten seconds.

In one embodiment, the connection request can be a voice request transmitted from a user through a webpage. In detail, the video wall control device 1 runs a video wall control system 100, and provides a video wall control interface 110 for the users to log in to the video wall control system 100, the users can log in to the video wall control system 100 from the video wall control interface 110 displayed on the webpage using an account and a password. The video wall control system 100 further provides a voice input interface (not shown in figure), and the users of the video device 2 can input the voice request on the voice input interface displayed on the webpage.

In other embodiments, the connection request can also be a voice request transmitted by a user through a video client. That is, the users can log in to the video wall control system 100 through the video client running on the video device 2, and send the voice request according to a voice input function provided by the video client.

The judging module 102 is used to determine whether the connection request is acceptable when the video wall control device 1 receives the connection request from the at least one video device 2.

In one embodiment, a video conference is taken as an example for description. The video wall control device 1 predetermines a conference call list. The conference call list includes serial numbers of the number of video devices 2 of the users who need to participate in the conference. The judging module 102 determines whether the serial number of the video device 2 transmitting the connection request is included in the predetermined conference call list. If the serial number of the video device 2 transmitting the connection request is included in the predetermined conference call list, the judging module 102 determines that the connection request is acceptable. If the serial number of the video device 2 transmitting the connection request is not included in the predetermined conference call list, the judging module 102 determines that the connection request is unacceptable.

The feedback module 103 is used to reject the connection request and return an error message to the video device 2 corresponding to the connection request when the judging module 102 determines that the connection request is unacceptable.

The acquiring module 104 is used to acquire configuration information of the at least one video device 2 when the video wall control device 1 receives the connection request from the at least one video device 2.

In one embodiment, the storage device 20 further stores a position number of each of the number of video devices 2 and configuration information corresponding to the position number. The position number can be a conference room number, such as conference room NO. 1, conference room NO. 2, etc. When the video wall control device 1 receives the connection request from the at least one video device 2, the acquiring module 104 acquires the position number of the at least one video device 2. In one embodiment, the connection request transmitted by the video device 2 includes the position number, the acquiring module 104 can acquire the position number of the at least one video device 2 according to the information included in the connection request.

Then, the judging module 102 further queries whether the configuration information corresponding to the acquired position number is stored in the storage device 20. If the configuration information corresponding to the acquired position number is stored in the storage device 20, the acquiring module 104 acquires the configuration information corresponding to the acquired position number from the storage device 20. If the configuration information corresponding to the acquired position number is not stored in the storage device 20, the feedback module 103 rejects the connection request and returns the error message to the at least one video device 2 transmitting the connection request.

The determining module 105 is used to determine the type of the at least one video device 2 according to the configuration information acquired by the acquiring module 104.

In one embodiment, the configuration information of each of the number of video devices 2 stored in the storage device 20 further corresponds to the type of each of the number of video device 2, accordingly, the determining module 105 determines the type of the at least one video device 2 according to the acquired configuration information and a relationship between the configuration information stored in the storage device 20 and the types of the number of video devices 2.

The loading module 106 is used to load a video control service corresponding to the type of the at least one video device 2.

In one embodiment, the video control service can be an application software, and can be invoked by the video wall control device 1 to project the content to be projected. The storage device 20 further stores the video control service corresponding to each type of the number of video devices 2, the loading module 106 acquires the video control service from the storage device 20 and loads the video control service corresponding to the type of the at least one video device 2.

It can be understood that, in other embodiments, the at least one video device 2 can transmit the video control service stored thereon to the video wall control device 1 itself, when the at least one video device 2 communicates with the video wall control device 1.

The control module 107 is used to project the content to be projected from the video device 2 on the video wall 30 according to the video control service loaded by the loading module 106, in response to the connection request.

In one embodiment, the control module 107 controls the video wall 30 to generate, change, or delete the projection window according to the loaded video control service, so as to display or not display the projection content on the video wall 30.

In detail, the video device 2 can transmit at least one voice control instruction to the video wall control device 1 according to the video control service in response to user operations, the control module 107 can recognize the at least one voice control instruction and project the content to be projected on the video wall 30 in response to the at least one voice instruction. For example, the voice device 2 selects the content to be projected in response to the user operation, the content to be projected can be a document, an image, or a video, transmits the voice control instruction including voice content of “project a document of a work plan on a projection window located at an upper right corner of the video wall” from the user, the video device 2 further transmits the document of the work plan to the video wall control device 1, the control module 107 controls the video wall 30 to display the document of the work plan on the projection window located at the upper right corner, that is, controls the video wall 30 to generate the projection window displaying the document of the work plan at the upper right corner of the video wall 30. It can be understood that, the control module 107 can also change a position or a size of the projection window, or delete the projection window to stop displaying the projection content.

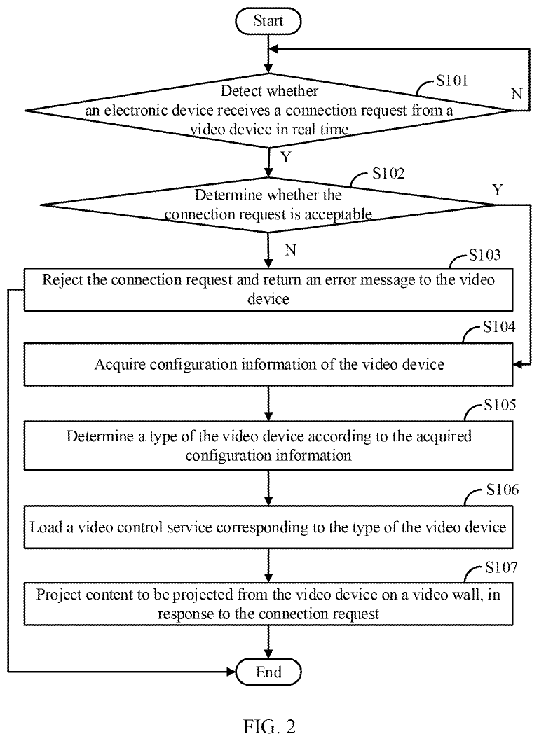

FIG. 2 illustrates a flowchart of a preferred embodiment of a video wall control method. According to different requirements, the illustrated order of blocks is by example only and the order of the blocks can be changed, some blocks can be removed.

Step S101, detect whether the video wall control device 1 receives a connection request from at least one video device 2 in real time. If the video wall control device 1 is detected to receive the connection request from the at least one video device 2, the process goes to step S102. If the video wall control device 1 is not detected to receive the connection request from the at least one video device 2, the process continues step S102.

Step S102, determine whether the connection request is acceptable. If the connection request is determined to be acceptable, the process goes to step S104. If the connection request is determined to be unacceptable, the process goes to step S103.

Step S103, reject the connection request and return an error message to the at least one video device 2 transmitting the connection request.

Step S104, acquire configuration information of the at least one video device 2.

Step S105, determine the type of the at least one video device 2 according to the acquired configuration information.

Step S106, load a video control service corresponding to the type of the video device 2.

Step S107, project the content to be projected from the video device 2 on the video wall 30 according to the loaded video control service, in response to the connection request.

It is believed that, the above embodiments are only used to illustrate the technical solutions of the present disclosure and not to limit them, although the present disclosure has been described in detail with reference to the preferred embodiments, the one with ordinary skill in the art should understand that, various changes or equivalent replacement may be made on the present disclosure, without departing from the spirit and scope of the present disclosure.

What is claimed is:

1. A video wall device comprising:
a processor;
a video wall;
a control interface connecting with a plurality of video devices in different types; and
a storage device storing configuration information of the plurality of video devices;
the processor comprising:
a detecting module, configured to detect whether the video wall device receives a connection request from at least one of the plurality of video devices;
an acquiring module, configured to acquire, in response that the video wall device is detected to receive the connection request from the at least one of the plurality of video devices, configuration information of the at least one of the plurality of video devices;
a determining module, configured to determine a type of the at least one of the plurality of video devices according to the acquired configuration information;
a loading module, configured to load a video control service corresponding to the type of the plurality of at least one of the video devices; and
a projecting module, configured to project content to be projected from the at least one of the plurality of video devices on the video wall according to the video control service loaded by the loading module in response to the connection request.

2. The video wall device according to claim 1, wherein the processor further comprises:
a judging module, configured to determine whether the connection request is acceptable, in response that the video wall device is detected to receive the connection request from the at least one of the plurality of video devices; and
a feedback module, configured to reject the connection request in response that the connection request is determined to be unacceptable, and return an error message to the at least one of the plurality of video devices transmitting the connection request.

3. The video wall device according to claim 1, wherein the storage device further stores a position number of each of the plurality of video devices and configuration information corresponding to the position number, the acquiring module further acquire the position number of the at least one of the plurality video devices in response that the video wall device receives the connection request from the at least one of the plurality video devices, the processor further comprises:
a judging module, configured to determine whether the storage device stores the configuration information corresponding to the acquired position number; and
the determining module further determines the type of the at least one of the plurality of video devices according to the acquired configuration information, in response that the storage device is determined to store the configuration information corresponding to the acquired position number.

4. The device according to claim 1, wherein the connection request is a voice request input by users through a webpage or a video client.

5. The device according to claim 1, wherein the project module controls the video wall to generate, change, or delete at least one projection window according to the loaded video control service, so as to display or stop displaying projection content on the video wall.

6. A video wall control method, implemented in a video wall control device, wherein the video wall control device comprises a storage device, a video wall, and a control interface, the control interface connects with a plurality of video devices in different types, the storage device stores configuration information of the plurality of video devices, the video wall control method comprising:
detecting whether the video wall device receives a connection request from at least one of the plurality of video devices;
acquiring, in response that the video wall device is detected to receive the connection request from the at least one of the plurality of video devices, configuration information of the at least one of the plurality of video devices;
determining a type of the at least one of the plurality of video devices according to the acquired configuration information;
loading a video control service corresponding to the type of the plurality of at least one of the video devices; and
projecting content to be projected from the at least one of the plurality of video devices on the video wall according to the loaded video control service, in response to the connection request.

7. The video wall control method according to claim 6, further comprising:
determining whether the connection request is acceptable, in response that the video wall device is detected to receive the connection request from the at least one of the plurality of video devices; and
rejecting the connection request in response that the connection request is determined to be unacceptable, and returning an error message to the at least one of the plurality of video devices transmitting the connection request.

8. The video wall control method according to claim 6, wherein the storage device further stores a position number of each of the plurality of video devices and configuration information corresponding to the position number, the video wall control method further comprising:
acquiring the position number of the at least one of the plurality video devices in response that the video wall device receives the connection request from the at least one of the plurality video devices;
determining whether the storage device stores the configuration information corresponding to the acquired position number; and
determining the type of the at least one of the plurality of video devices according to the acquired configuration information, in response that the storage device is determined to store the configuration information corresponding to the acquired position number.

9. The video wall control method according to claim 6, wherein the connection request is a voice request input by users through a webpage or a video client.

10. The video wall control method according to claim 6, wherein loading a video control service corresponding to the type of the plurality of at least one of the video devices comprises:
controlling the video wall to generate, change, or delete at least one projection window according to the loaded video control service, so as to display or stop displaying the projection content on the video wall.
